(19) United States
(12) Patent Application Publication
(10) Pub. No.: US 2008/0183551 A1
(43) Pub. Date: Jul. 31, 2008

(54) TRANSACTION FEEDBACK MECHANISMS

(75) Inventor: Kamal Jain, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/668,784

(22) Filed: Jan. 30, 2007

(51) Int. Cl. G06Q 99/00

(52) U.S. Cl. 705/10

(57) ABSTRACT

Randomness and/or blind submissions are employed to substantially remove biased feedback from online transaction rating processes. In one instance, a probability mechanism is determined before a transaction occurs but is not employed until after the transaction occurs. In another instance, feedback is collected from participants in a transaction in a blind manner. These mechanisms allow participants to submit their feedback without being biased by the other participant's feedback, producing less biased feedback submissions.

### BACKGROUND

Many businesses today maintain an online presence. Customers of brick and mortar businesses are instantly familiar with their online counterpart businesses. However, many online businesses do not have physical store locations and strictly sell products and services over the Internet. Customers are often wary of ordering from such businesses because they don't have a known reputation. To alleviate some of this apprehension, marketplace rating sites have sprung up all over the Internet. The ratings are meant to give participants a chance to evaluate their transaction experiences with a particular merchant. These ratings are then available to other participants of the marketplace to indicate how trustworthy a given participant is.

In most rating systems, the participants are allowed to view ratings as soon as the feedback is available. This tends to bias the other participant in a transaction. Often the ratings are paramount to maintaining customers and/or to maintain participation in a marketplace (e.g., participating in an online auction service, etc.) and, thus, both parties to a transaction may try to wait each other out before they provide their feedback to a rating system. Neither party wants to leave unfavorable feedback if they will receive an even lower feedback rating. Thus, by waiting for the other party, they are safe to leave their feedback without worrying about retaliation. So, both parties tend to hold out or leave better-than-deserved feedback to avoid receiving bad feedback in return. Thus, the transaction ratings are often much higher than they should be, making the rating system extremely biased and ineffective.

### SUMMARY

Transaction feedback mechanisms employ, for example, randomness and/or blind submissions to substantially remove biased feedback from an online transaction. One instance utilizes an a priori probability mechanism to determine which participant in a transaction is permitted to leave feedback. The probability itself can be biased towards buyer or seller if desired. The probability mechanism is determined before the transaction occurs but is not employed until after the transaction. Since neither party knows which one can leave feedback, they tend to select the most fair probability mechanism for both parties before a transaction occurs. However, fairness need not be considered during the selection process. Because only one party is ultimately allowed to leave feedback, this negates the possibility of retaliation feedback and results in a substantially unbiased feedback submission.

In another instance, feedback is collected from participants in a transaction in a blind manner. This allows both participants to submit their feedback without being biased by the other participant's feedback, resulting in a more unbiased feedback submission. In one example, a time period can be established for obtaining the participant's feedback. When the time period expires, the feedback is released to the participants, etc. In another example, the release of the feedback can be withheld until the participants have each submitted feedback. The feedback is then released at that point. This, again, eliminates biasing of the feedback caused by knowledge of the other participant's potential and/or actual feedback submission.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of an online transaction feedback system in accordance with an aspect of an embodiment.

FIG. 2 is another block diagram of an online transaction feedback system in accordance with an aspect of an embodiment.

FIG. 3 is a flow diagram of a method of rating participants in online transactions in accordance with an aspect of an embodiment.

FIG. 4 is another flow diagram of a method of rating participants in online transactions in accordance with an aspect of an embodiment.

FIG. 5 illustrates an example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers.

Participants in online transactions can utilize the feedback submission mechanisms disclosed herein to provide less biased feedback relating to the transaction. This can be accomplished utilizing random selection mechanisms and/or blind submission mechanisms and the like. These mechanisms remove biasing that occurs when participants leave feedback based on the feedback left by other participants. This feedback knowledge greatly influences rating systems because participants do not want to gain negative feedback in retaliation—even when transaction experiences were very poor. This “tit-for-tat” biasing greatly exaggerates feedback towards perfection which is often far from what accurate feedback would dictate. Without this biasing, participants in a marketplace are assured more truthful merchant and/or customer ratings, allowing for a safer marketplace experience and greatly reducing fraud and/or transaction dissatisfaction and the like.

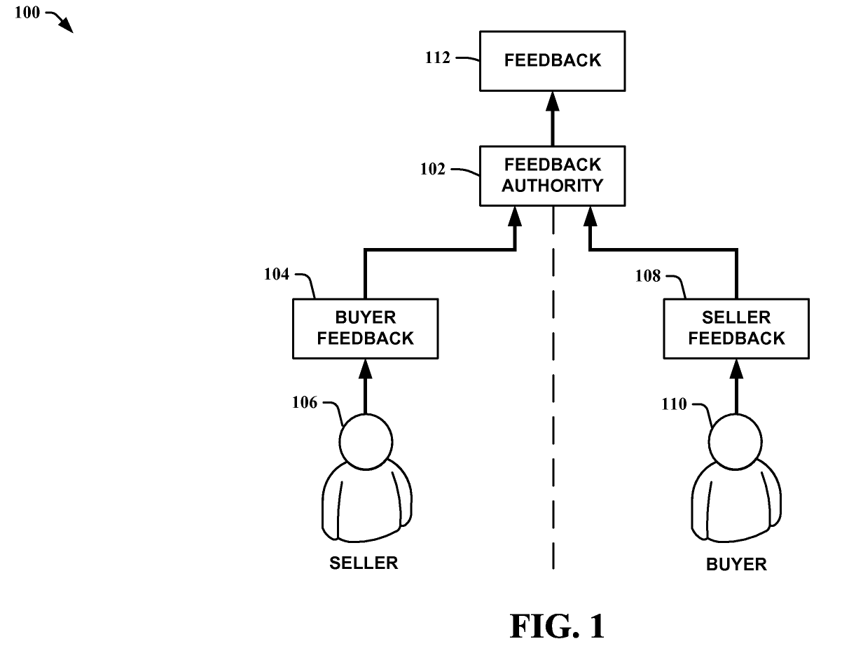

FIG. 1 illustrates an online transaction feedback system 100 that utilizes a feedback authority 102 to accept buyer feedback 104 from a seller 106 and/or seller feedback 108 from a buyer 110 and provide feedback 112. The feedback authority 102 accepts buyer feedback 104 and/or seller feedback 108 in an independent manner. Neither the seller 106 nor the buyer 110 is cognizant of each other's feedback 104, 108 that is submitted to the feedback authority 102. This substantially reduces biasing of feedback based on another party's feedback. Since the buyer feedback 104 and/or the seller feedback 108 is kept confidential, the feedback authority 102 can decide to disclose the feedback 112 based on, for example, a time duration (e.g., one week after a transaction is completed, etc.), a time of day (e.g., at 3 pm on Thursday, etc.), and/or an event occurrence (e.g., after both parties have submitted feedback and/or waived their right to leave feedback, etc.) and the like.

By controlling the buyer and/or seller feedback 104, 108 in an independent and undisclosed fashion, the feedback 112 provides a more accurate representation of actual satisfaction amongst the transaction participants (e.g., the seller 106 and/or buyer 110). This substantially increases the value of the feedback 112 to other participants in an online marketplace and/or online auction service and the like. Confident participants tend to spend more money and, thus, trust in the feedback 112 can bring an increased number of transactions to the marketplace, etc. This, in turn, can bring additional revenues in advertising, etc. to the marketplace as well. The feedback 112 can also affect the quality of merchants who participate in the marketplace, driving away those with low feedback scores.

It is conceivable that participants in a marketplace can still try to manipulate time and/or event based feedback systems. For example, if a seller delays shipping a product to a buyer, the seller may anticipate that they will receive poor feedback from the buyer. Thus, to minimize the impact of such a bad rating, the seller may preemptively decide to give a bad rating to the buyer. The seller hopes in this situation that mutual poor feedback will decrease the impact of the buyer's poor rating of the seller. This can happen because a future buyer might have a hard time determining whether the seller was at fault for delaying the shipment without cause or whether the seller delayed the shipment due to the buyer failing to pay on time.

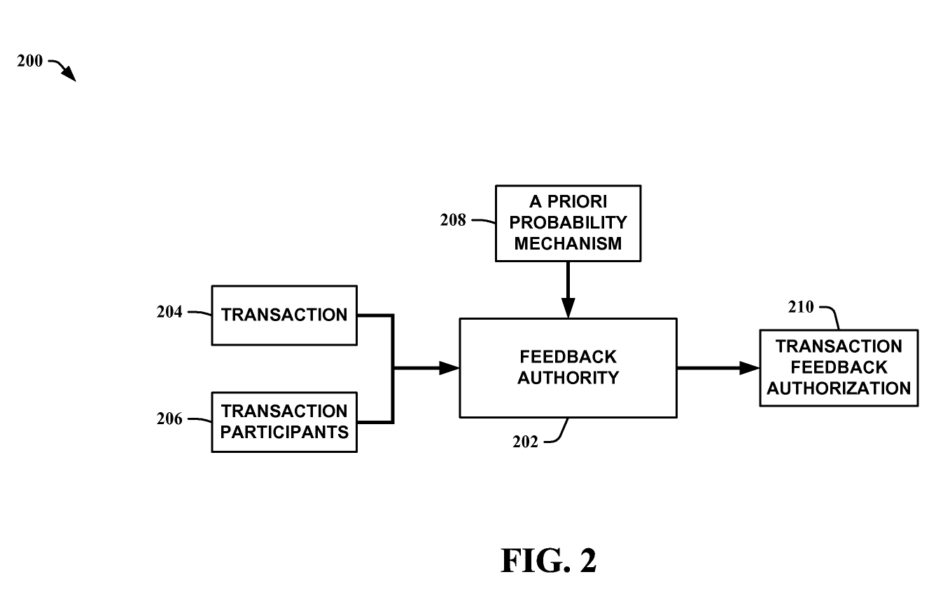

To counteract the above scenario and others, FIG. 2 depicts an online transaction feedback system 200 that employs a feedback authority 202 and an a priori probability mechanism 208 to facilitate feedback determination. The feedback authority 202 obtains information relating to a transaction 204 and/or transaction participants 206 and employs the a priori probability mechanism 208 to determine transaction feedback authorization 210. The a priori probability mechanism 208 is determined before the transaction 204 is completed. The selection of the a priori probability mechanism 208 can be accomplished by the transaction participant 206 and/or the feedback authority 202. Biasing (e.g., weighting) of a probability factor utilized in the a priori probability mechanism 208 is permitted and can be decided also by the transaction participants 206 and/or the feedback authority 202.

The feedback authority 202 does not employ the a priori probability mechanism 208 until after the transaction 204 is completed. Since the a priori probability mechanism 208 is decided before the transaction 204, the transaction participants 206 can be motivated to select an agreeable, fair and/or equitable a priori probability mechanism 208 (e.g., neither party desires to be at a disadvantage since neither knows which party might be able to leave feedback—prompting both parties to be on their best behavior, etc.). In some instances, however, the probability factor can be substantially biased (e.g., weighted for higher likelihood that a buyer will rate a seller and/or a seller waives a right to rate a buyer, etc.). The feedback authority 202 applies the a priori probability mechanism 208 after the transaction 204 is completed to provide the transaction feedback authorization 210. The transaction feedback authorization 210 delineates which of the transaction participants 206 is allowed to leave feedback. The transaction feedback authorization 210 is typically employed in an online marketplace and/or online auction service, etc. rating system to determine which feedback submission to utilize.

In an example scenario, a coin toss can be employed as the a priori probability mechanism 208. This allows the transaction participants 206 to have an equal probability factor of rating each other. The feedback authority 202 can then utilize the coin toss (i.e., the a priori probability mechanism) after the transaction 204 is completed to determine which of the transaction participants 206 can leave feedback. If the coin toss comes up heads then, for example, a seller can rate a buyer and if it comes up tails then the buyer can rate the seller, etc. The feedback authority 202 employs the a priori probability mechanism 208 when the transaction participants 206 are ready to rate each other (e.g., after the transaction 204 is completed). The feedback authority 202 also provides the transaction feedback authorization 210 before feedback is collected from the transaction participants 206.

As mentioned previously, the probability factor utilized by the a priori probability mechanism 208 is not required to be fair, but is determined before the transaction is initiated. For example, a seller may waive the right to rate. This means, using the coin toss scenario, that the probability of the coin coming up heads is zero and tails is 1. Or, the seller may waive the right partially. For example, the seller may desire a 25% and 75% probability split. Or, in the scenario where a buyer needs to build their rating, a seller can offer a reversed split of 75% and 25%. The online transaction feedback system 200 functions regardless of who and/or how the probabilities are decided. The a priori probability mechanism 208 remains stable after its determination.

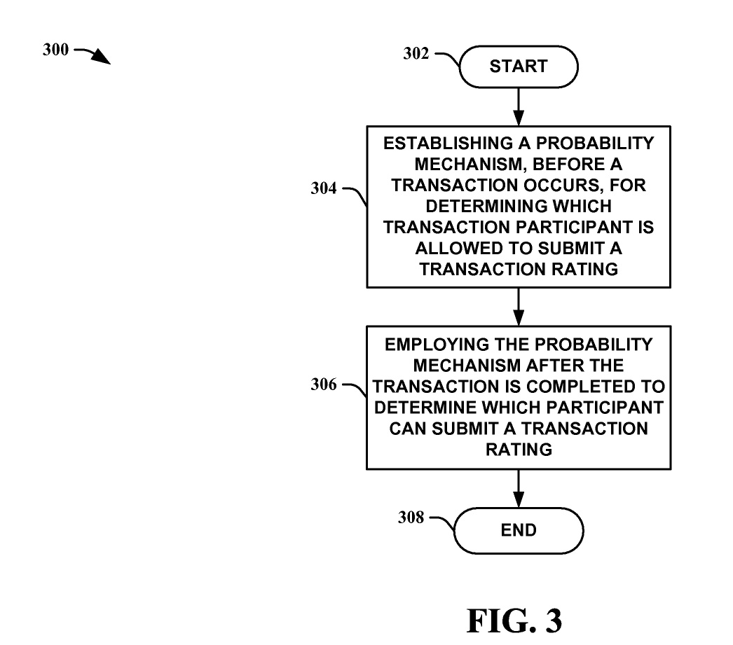

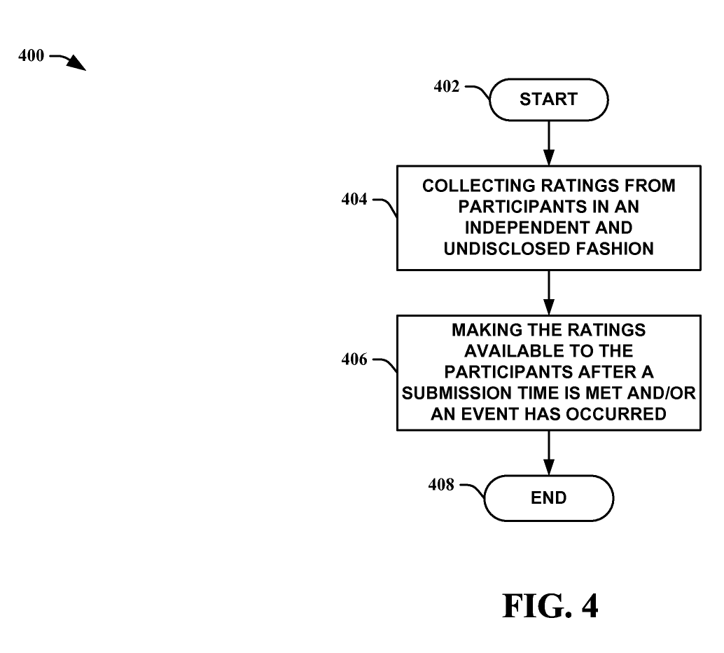

In view of the exemplary systems shown and described above, methodologies that may be implemented in accordance with the embodiments will be better appreciated with reference to the flow charts of FIGS. 3 and 4. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 3, a flow diagram of a method 300 of rating participants in online transactions in accordance with an aspect of an embodiment is illustrated. The method 300 starts 302 by establishing a probability mechanism, before a transaction occurs, for determining which transaction participant is allowed to submit a transaction rating 304. The selection of the probability mechanism can be accomplished by a transaction participant and/or a third party that gathers feedback ratings. Biasing (e.g., weighting) of a probability factor utilized in the probability mechanism is permitted and can be decided by transaction participants and/or the third party.

The probability mechanism is employed after the transaction is completed to determine which participant can submit a transaction rating 306, ending the flow 308. Since the probability mechanism is decided before the transaction, the transaction participants can be motivated to select an agreeable, fair and/or equitable probability mechanism (e.g., neither party desires to be at a disadvantage since neither knows which party might be able to leave feedback—prompting both parties to be on their best behavior, etc.). In some instances, however, the probability factor can be substantially biased (e.g., weighted for higher likelihood that a buyer will rate a seller and/or a seller waives a right to rate a buyer, etc.). This method 300 can be employed in online marketplace and/or auction rating systems and the like to determine which feedback submission to utilize.

Turning to FIG. 4, another flow diagram of a method 400 of rating participants in online transactions in accordance with an aspect of an embodiment is depicted. The method 400 starts 402 by collecting ratings from participants in an independent and undisclosed fashion 404. For example, neither a seller participant nor a buyer participant is cognizant of each other's submitted feedback. This substantially reduces biasing of feedback based on the other party's feedback and provides a more accurate representation of true participant satisfaction and the like for a given transaction.

The ratings are then made available to the participants after a submission time is met and/or an event has occurred 406, ending the flow 408. Since the participant feedback is kept confidential, the feedback can be disclosed based on, for example, a time duration (e.g., one week after a transaction is completed, etc.), a time of day (e.g., at 3 pm on Thursday, etc.), and/or an event occurrence (e.g., after both parties have submitted feedback and/or waived their right to leave feedback, etc.) and the like. By controlling the feedback in an independent and undisclosed fashion, the feedback ratings provide a more accurate representation of actual satisfaction amongst the transaction participants (e.g., a seller and/or a buyer). This substantially increases the value of the feedback ratings to other participants in, for example, online marketplaces and/or auction services and the like. Confident participants tend to spend more money and, thus, trust in the feedback ratings can bring an increased number of transactions to the marketplace. This, in turn, can bring additional revenues in advertising, etc. to the marketplace as well. The feedback ratings can also affect the quality of merchants who participate in the marketplace, driving away those with low feedback scores.

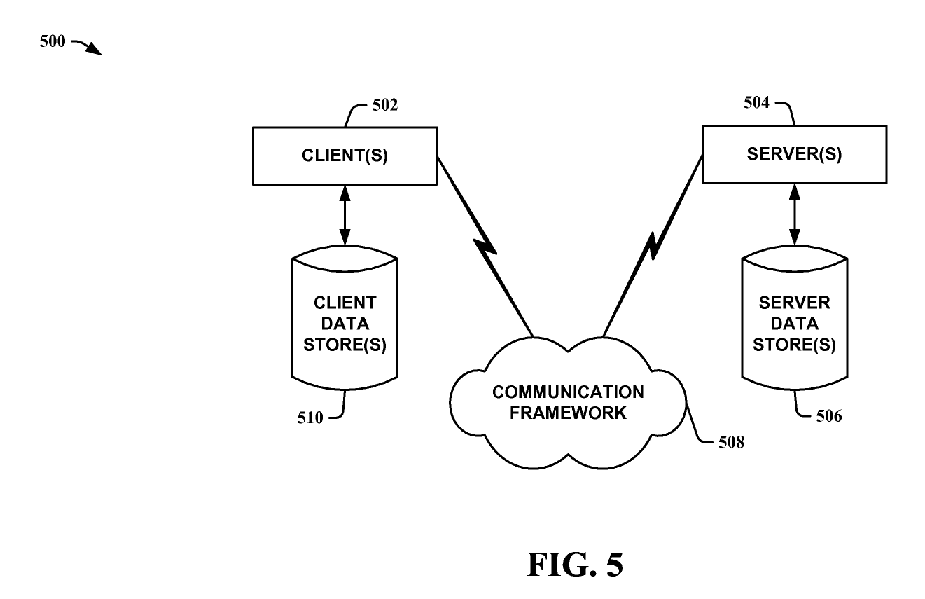

FIG. 5 is a block diagram of a sample computing environment 500 with which embodiments can interact. Feedback can be submitted by participants utilizing a client 502 and/or feedback can be collected and/or derived utilizing a server 504 and the like in such a system 500. Feedback can also be collected on a client 502 and then provided to a server 504, etc. The system 500 further illustrates a system that includes one or more client(s) 502. The client(s) 502 can be hardware and/or software (e.g., threads, processes, computing devices). The system 500 also includes one or more server(s) 504. The server(s) 504 can also be hardware and/or software (e.g., threads, processes, computing devices). One possible communication between a client 502 and a server 504 can be in the form of a data packet adapted to be transmitted between two or more computer processes. The system 500 includes a communication framework 508 that can be employed to facilitate communications between the client(s) 502 and the server(s) 504. The client(s) 502 are connected to one or more client data store(s) 510 that can be employed to store information local to the client(s) 502. Similarly, the server(s) 504 are connected to one or more server data store(s) 506 that can be employed to store information local to the server(s) 504.

It is to be appreciated that the systems and/or methods of the embodiments can be utilized in online marketplace transaction feedback facilitating computer components and non-computer related components alike. Further, those skilled in the art will recognize that the systems and/or methods of the embodiments are employable in a vast array of electronic related technologies, including, but not limited to, computers, servers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for rating participants in online transactions, comprising:
establishing a probability mechanism, before a transaction occurs, for determining which transaction participant is allowed to submit a transaction rating; and
employing the probability mechanism after the transaction is completed to determine which participant can submit a transaction rating.

2. The method of claim 1 further comprising:
employing the probability mechanism after a seller participant has received payment and a buyer participant has received transaction associated goods and/or services.

3. The method of claim 1 further comprising:
employing a probability mechanism with a biased probability towards a transaction participant.

4. The method of claim 1 further comprising:
determining a probability mechanism based on, at least in part, input from at least one transaction participant.

5. The method of claim 1 further comprising:
utilizing a probability mechanism with a probability biased towards a participant who is a buyer in the transaction.

6. The method of claim 1 further comprising:
employing a third party to the transaction to determine a probability for the probability mechanism.

7. An online auction service that employs the method of claim 1.

8. An online marketplace that employs the method of claim 1.

9. A method for rating participants in online transactions, comprising:
collecting ratings from participants in an independent and undisclosed fashion; and
making the ratings available to the participants after a submission time is met and/or an event has occurred.

10. The method of claim 9 further comprising:
disclosing ratings to participants after all participants have submitted their ratings and/or waived their rights to submit their ratings.

11. The method of claim 9 further comprising:
revealing ratings after a pre-determined length of time initiated by a transaction event.

12. The method of claim 9 further comprising:
divulging ratings after a time-of-day has been reached subsequent to a transaction event.

13. The method of claim 9 further comprising:
disclosing ratings after all participants have submitted their ratings and/or waived their right to submit their rating.

14. The method of claim 9 further comprising:
collecting ratings after a seller participant has received payment and a buyer participant has received transaction associated goods and/or services.

15. An online auction service that employs the method of claim 9.

16. An online marketplace that employs the method of claim 9.

17. A system that determines online transaction feedback, comprising:
means for determining a probability mechanism before an occurrence of an online marketplace transaction; the probability mechanism determined by, at least in part, participants of the online marketplace transaction; and
means for determining which of the participants can submit feedback via employment of the probability mechanism after completion of the online marketplace transaction.

18. A computer readable medium having stored thereon computer executable components of the system of claim 17.

19. A device employing the method of claim 1 comprising a computer, a server, and/or a handheld electronic device.

20. A device employing the method of claim 9 comprising a computer, a server, and/or a handheld electronic device.
